(19) United States
(12) Patent Application Publication
(10) Pub. No.: US 2014/0304031 A1
(43) Pub. Date: Oct. 9, 2014

(54) METHOD AND SYSTEM FOR PERFORMING ANALYSIS OF ITEM ORDER FREQUENCY

(71) Applicant: ORACLE INTERNATIONAL CORPORATION, Redwood Shores, CA (US)

(72) Inventors: John David HOLDER, Centennial, CO (US); Aaron JOHNSON, Castle Pines, CO (US)

(73) Assignee: ORACLE INTERNATIONAL CORPORATION, Redwood Shores, CA (US)

(21) Appl. No.: 14/248,225

(22) Filed: Apr. 8, 2014

Related U.S. Application Data
(60) Provisional application No. 61/809,617, filed on Apr. 8, 2013.

(51) Int. Cl. G06Q 30/02

(52) U.S. Cl. CPC G06Q 30/0201
USPC 705/7.29

(57) ABSTRACT

An improved approach is described for identifying frequently ordered items. This approach allows the counts for the months that are currently relevant to be summed quickly and ranked at runtime so the items with the highest frequency can be recommended. In addition, this approach provides very up-to-date data at very low levels of incremental expense.

### CROSS-REFERENCE TO RELATED APPLICATIONS

The present application claims the benefit of priority to U.S. Provisional Patent Application Ser. No. 61/809,617, entitled “Method and System for Performing Analysis of Item Order Frequency” (Attorney Docket No. ORA130844-US-PSP), filed Apr. 8, 2013, which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND AND SUMMARY

Many businesses and organizations employ one or more business applications, and in some cases, suites of business applications, to provide visibility and control over various aspects of the business. Such “business applications” (or, as they are sometimes called, “enterprise applications”) can include, without limitation, customer relations management (“CRM”) applications, online transaction processing (“OLTP”) applications, enterprise resource planning (“ERP”) applications, supply chain management applications, and other applications dealing with various finance, accounting, manufacturing, and/or distribution functions, to name but a few examples. Exemplary enterprise application suites include, without limitation, Oracle Fusion, Oracle eBusiness Suite and JD Edwards Enterprise One, all of which are available from Oracle Corporation of Redwood Shores, Calif.

For many of these enterprise/business applications, it would be very useful to include functionality to provide lists of relevant items to recommend to customers as they are buying items. One method to determine these items is to identify items that were frequently purchased during the same time of year (and/or season) in past years. To be useful, these lists should be accurate enough to reflect the latest sales order information.

The problem is that there is potentially a very large set of data to be queried to find frequently ordered items as many clients process many thousands of sales orders per day. If the approach to identify the frequently purchased items is not performed efficiently enough, then excessive expense/overhead of the process will detrimentally affect the desirability of performing the analysis. In addition, failing to provide an approach that can keep the analysis up-to-date leads to inaccurate data that is of little use to an enterprise.

One possible approach to this problem is to query the sales order history during runtime to generate the desired analysis results. However, given the large volumes of data that typically needs to be queried, this type of an approach may take an excessive amount of time to return the analysis results. This is problematic since getting accurate data very quickly is extremely important to the customer service representatives taking the orders.

Another possible approach is to determine the current counts for each customer in a batch calculation on an interval-based basis. The drawback to this approach is that the batch process must be run each interval (e.g., month) to update the counts. However, in the intervals between these scheduled updates, the analysis data can becomes quite stale and/or inaccurate as time passes since the last run of the analysis. In addition, with large volumes of data and customers, this process could take an excessively long amount of time to complete, consuming server resources while counting the same data repeatedly each month.

To address these problems, the present disclosure is directed to an improved approach for identifying frequently ordered items. According to some embodiments, the invention operates by first performing a pre-calculation from historical data, e.g., by generating item counts for each customer/entity for all of the months in a desired date range. These counts are updated when ongoing sales orders are processed. This approach allows the counts for the months that are currently relevant to be summed quickly and ranked at runtime so the items with the highest frequency can be recommended. In addition, this approach provides very up-to-date data at very low levels of incremental expense.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE DRAWINGS

The drawings illustrate the design and utility of embodiments, in which similar elements are referred to by common reference numerals. These drawings are not necessarily drawn to scale. In order to better appreciate how the above-recited and other advantages and objects are obtained, a more particular description of the embodiments will be rendered which are illustrated in the accompanying drawings. These drawings depict only exemplary embodiments and are not therefore to be considered limiting of the scope of the claims.

FIG. 1 shows an architecture of a system for analyzing item order frequency in accordance with some embodiments.

FIG. 2 illustrates a flowchart of an approach for analyzing item order frequency in accordance with some embodiments.

FIG. 3 illustrates a flowchart of an approach for performing pre-calculations in accordance with some embodiments.

FIGS. 4A and 4B illustrate flowcharts of an approach for updating the analysis data in accordance with some embodiments.

FIGS. 5A-5D illustrate an example of an approach for updating the analysis data in accordance with some embodiments.

FIG. 6 illustrates a flowchart of an approach for generating recommendations based upon the analysis data in accordance with some embodiments.

FIG. 7 depicts a computerized system on which an embodiment of the invention can be implemented.

### DETAILED DESCRIPTION

The present disclosure is directed to an improved approach for identifying frequently ordered items. According to some embodiments, the invention operates by first performing a pre-calculation from historical data, e.g., by generating item counts for each customer/entity for all of the months in a desired date range. These counts are updated when ongoing sales orders are processed. This approach allows the counts for the months that are currently relevant to be summed quickly and ranked at runtime so the items with the highest frequency can be recommended. In addition, this approach provides very up-to-date data at very low levels of incremental expense.

Various embodiments are described hereinafter with reference to the figures. It should be noted that the figures are not drawn to scale and that the elements of similar structures or functions are represented by like reference numerals throughout the figures. It should be noted that the figures are only intended to facilitate the description of the embodiments. They are not intended as an exhaustive description of the invention or as a limitation on the scope of the invention. In addition, an illustrative embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiment” or “in other embodiments” in various places throughout this specification are not necessarily referring to the same embodiment or embodiments.

For the purposes of explanation, one or more embodiments are illustratively described with reference to CRM applications. It is noted, however, that the invention may be applied to other types of enterprise applications as well, and is not to be limited to CRM applications unless explicitly claimed as such.

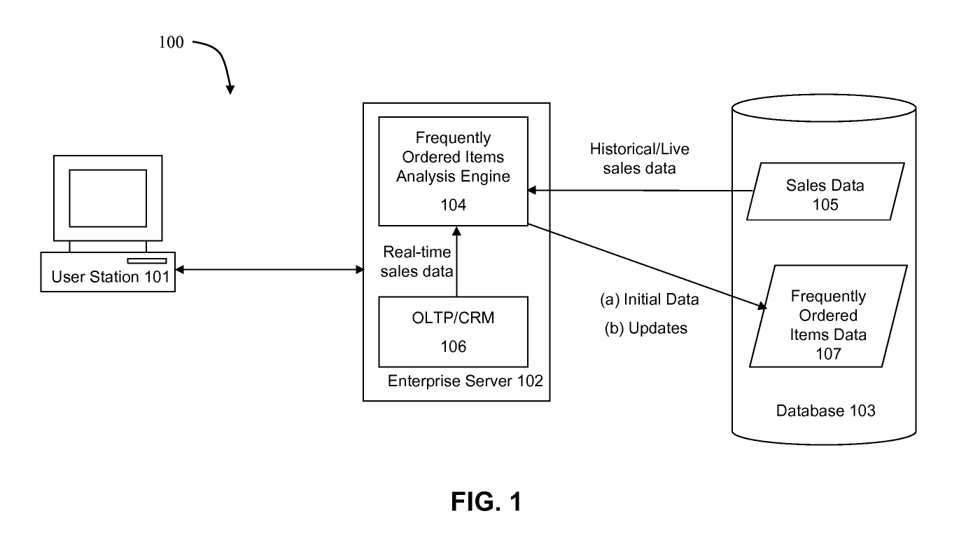

FIG. 1 illustrates an example system 100 which may be employed to implement calculation of frequently ordered items in accordance with some embodiments. The system 100 includes one or more users at one or more user stations 101 that operate the system to operate an enterprise application on an enterprise server 102. The user station 101 comprises any type of computing station that may be used to operate or interface with the applications in the system. Examples of such user stations include for example, workstations, personal computers, or remote computing terminals. In some embodiments, the user station 101 may be a mobile device, such as a tablet, phone, or touchscreen device. The user station 101 comprises a display device, such as a display monitor, for displaying a user interface to users at the user station. The user station 101 also comprises one or more input devices for the user to provide operational control over the activities of the system, such as a mouse, keyboard, joystick, or touchscreen, to manipulate a graphical user interface to generate user inputs (e.g., by manipulating a pointing object or cursor).

The data operated upon by the system 100 may be stored in a computer readable storage device, such as a database 103. The computer readable storage device may comprise any combination of hardware and software that allows for ready access to the data that is located at the computer readable storage device. For example, the computer readable storage device could be implemented as computer memory operatively managed by an operating system. The computer readable storage device could also be implemented as an electronic database system having storage on persistent and/or non-persistent storage.

The enterprise server 102 comprises a Frequently Ordered Items analysis engine 104. This analysis engine 104 performs pre-calculations using sales data 105 from the database 103. The pre-calculation process will pre-calculate the item counts in the time period of interest and to then store the counts in a separate data structure. For example, the pre-calculations can be used to generate a bucket for each month for each year of the analysis period, which may be stored in Frequently Ordered Item Data 107 (hereinafter FOI data 107). Each bucket may include a list of the top n items that were ordered in the time period corresponding to that bucket, e.g., to identify to most frequently ordered items for the corresponding month.

In some embodiments, sales data 105 may comprise historical sales data and live sales data. Historical sales data comprises data for sales orders that have completed their sales cycles, while live sales data may correspond to sales orders that have been previously received but have not yet reached the end of their sales cycles. Both historical sales data and live sales data may be used during pre-calculation. When a sales order of the live sales data reaches the end of its sales life cycle, it may be moved into historical sales data, and the corresponding bucket(s) may be updated if necessary.

As sales orders are entered and/or cancelled using an enterprise application (e.g., CRM and/or OLTP application 106), the analysis engine 104 increments or decrements the appropriate count(s) for the appropriate bucket. This updating process can be performed in real-time as the orders are being processed at CRM/OLTP application 106. In this way, the counts maintained at FOI data 107 are kept current and the process to initially load the tables of sales data 105 is only needed once.

It is understood that in some embodiments, counts may refer to a number of items ordered (e.g., 100 snowboards were ordered in the month of January), while in other embodiments, counts may refer to a number of line items containing the item (e.g., 70 orders in January contained snowboards). In addition, it is understood that items may refer to physical products, non-physical products, and/or services.

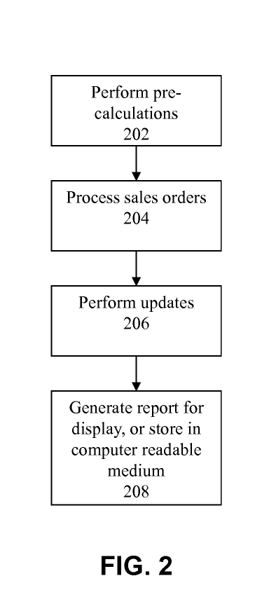

FIG. 2 shows a top-level flowchart of a process for analyzing item order frequency according to some embodiments of the invention. The process begins at 202 by performing pre-calculations on the existing sales data (e.g., historical sales data and live sales data stored on the database). As previously noted, there is potentially a very large set of data to be queried to find frequently ordered items, as many clients process many thousands of sales orders per day. The present approach of pre-calculating the item counts is efficient because it only needs to be performed once, while still being maintained on an ongoing and efficient basis. It is understood that in some other embodiments, pre-calculating the item counts may be performed on at certain intervals, such as once a month (e.g., such that the accuracy of the maintained item order counts can be regularly verified).

The pre-calculations can be performed with regards any set of zero or more customers. For example, the pre-calculations can be performed on a customer-basis, where the item counts for each customer are separately maintained. The items counts can also be performed without regard to any particular customer, but across the board for all customers. Another example approach is to perform the analysis on an industry or segment basis. As is evident, the invention is flexible enough to be applied to perform the item frequency analysis for zero entities, a particular entity, or for any grouping of entities.

In some embodiments, by storing the counts at the customer level, this allows counts to be very easily found for related customers. For example, if ten customers are determined to be related, the system can quickly get counts for all ten customers to find the items to recommend as one of those customers is making an order.

The pre-calculations can be performed for any desired time frame, e.g., by designating a starting month/year. In addition, the pre-calculations can be performed at any desired level of granularity. For example, the embodiment can be configured to create buckets that correspond to each month of the analysis time frame. In this approach, the item counts are identified for each of the months in the analysis time period, and are then stored in the bucket for a respective month. This allows the counts for the months that are currently relevant to be summed quickly and ranked at runtime so the items with the highest frequency can be recommended. Other levels of granularity may also be employed, e.g., by season, multi-month period, and years. For ease of explanation, this specification will primarily refer to the granularity as being in terms of months, although it is understood that the embodiments may be applied to any other level of granularity.

By storing the counts for each month, the customer can always find counts for the relevant season by defining how many months forward and backward they want to include and how many years they want to go back. This setup can be changed at any time to adjust which months are included in the count without requiring a reload of the data. For example, if a customer wishes to include one month forward and backwards, and to include data for the previous two years, and the current month is February, then counts for January to March of the previous two years, as well as January and February of the current year may be retrieved in order to determine frequently ordered items to recommend.

In some embodiments, the pre-calculation process will truncate the results for each month so counts that are statistically unimportant are removed to keep the buckets small, as to allow for efficient retrieval at runtime.

At 204, sales orders are received (e.g., at the OLTP/CRM application), and sales order lines are entered or cancelled. As sales orders are processed, the counts for the appropriate bucket are updated (e.g., incremented or decremented) at 206, so the counts are kept current and the process to initially load the table (pre-calculation) is only needed once.

The analysis results can then be displayed to a user on a display device at 208. For example, a customer service representative (CSR) may review the analysis data in real-time while conversing with a customer or potential customer, e.g., to use the item frequency data to identify cross-selling or upselling opportunities. The analysis results can also be stored in a tangible computer readable storage medium.

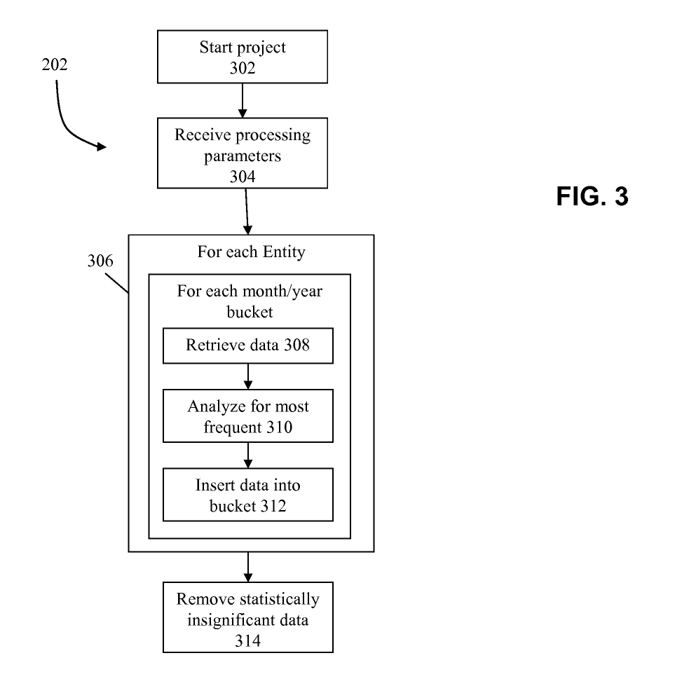

FIG. 3 shows a flowchart of an approach to perform the pre-calculation process according to some embodiments. The process begins by starting a new project at 302, which may involve clearing of any existing work files/spaces for pre-existing projects.

At 304, processing parameters are received for the pre-calculations. These processing parameters may include, for example, information about the granularity and time frame for the analysis (e.g., granularity is by month, time frame is from January 2010 to present). A determination can be made of the first time bucket based on the month/year window(s). In some embodiments, the number of buckets is the number of months within the time period, with the first time bucket being the first month in the time period. Processing parameters may also include whether the buckets will be created and maintained on a customer-basis, industry-basis, or any other type of grouping basis or combination of grouping bases.

At 306, the process then loops through subsequent processing for each entity of interest (e.g., using a for-each loop). In some embodiments, the processing is performed on a customer-basis, and therefore the for-each loop is performed for each relevant customer. In some cases there may be multiple customer entities within a single company. Therefore, the for-each loop may be separately applied on the basis of each customer entity within each company. In other embodiments, an entity may be a grouping of customers, wherein the grouping may be by industry segment, geography, or any other relevant criteria or combination of criteria as defined in the processing parameters.

The processing is also performed for each month/year bucket for the desired time period. At 308, the data for the appropriate month/year is queried from the sales database for each entity of interest, e.g., using a query similar to the following:

SELECT Item, Count (Item) FROM Sales_Order_History_Table

WHERE Customer=Specific_Customer(s) and time/month/date in Time Bucket;

This query selects the items from the sales order and/or sales history table(s) and performs a count of the retrieved items. The WHERE clause limits the query to the items for specific customer(s) and also for the specific time period associated with the bucket of interest.

At 310, analysis is performed on the retrieved data to identify the most frequently ordered items for the time period associated with the bucket. Any suitable approach can be taken to identify the most frequent ordered items. For example, the data may be sorted and a top n items are identified, where n is any suitable or desired number, e.g., the top 30 ordered items. Alternatively, threshold sales values can be configured such that any items ordered more than n times are identified. Yet another approach is to identify the top n percentage of items ordered in the bucket time period, e.g., top 10%.

At 312, the identified items are then inserted into the respective bucket. Associated information may also be inserted into the bucket. For example, the item count, customer name/identifier, company name, industry segment, etc. may also be placed into the bucket.

At 314, the process can also optionally remove any statistically insignificant items from the buckets. The step truncates the results for each month so that counts that are statistically unimportant are removed. For example, in some embodiments, only a top n items are kept in the bucket, while any other items are discarded. In other embodiments, a top n percent of items, or only items having an item count exceeding a certain value n, are kept. This keeps the bucket data structure (e.g., table) as small as possible for efficient retrieval at runtime. What is considered to be statistically insignificant information may be determined by one or more processing options or pieces of customer-specified information. For example, in some embodiments some buckets may remove statistically insignificant information based upon a default setting, while other buckets for particular customers may use a different setting.

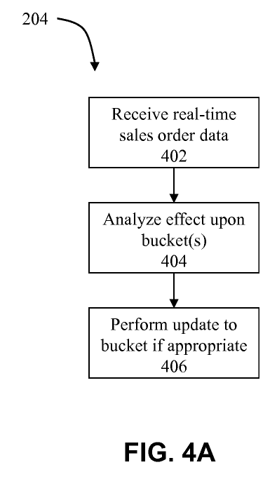

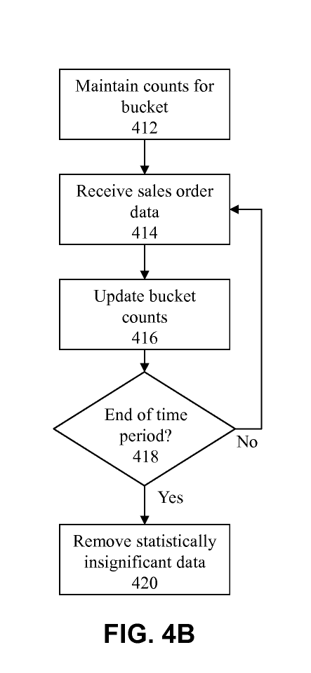

FIG. 4A shows a flowchart of an approach to update the buckets with ongoing sales data. In some embodiments, the update process is performed in real-time as sales orders are being processed. Therefore, at 402, the process will receive real-time sales order data as they are being entered by CSRs using CRM and/or OLTP enterprise applications.

At 404, the real-time sales order data is analyzed with respect to their effect upon the frequently ordered item counts in the buckets. This may comprise identifying the correct bucket to update. For example, in addition to identifying the bucket(s) corresponding to the current time period, a bucket corresponding to the particular customer associated with the order, or a customer group of which the particular customer is a member of, is identified. If no buckets are identified (e.g., the customer is a new customer, and thus there are no existing buckets corresponding to the customer), a new bucket may be created.

If appropriate, updates are performed upon the buckets at 406. What this means is that as sales order lines are entered or cancelled, the count for the appropriate bucket is incremented or decremented. This allows the item counts to be kept current within the buckets.

FIG. 4B shows a flowchart of a process for updating a bucket with received real-times sales order data. At 412, each bucket for the current time period maintains zero or more counts, corresponding to items that have been ordered during the time period. In some embodiments, when a bucket is first created it contains zero counts, as no items have yet been ordered during that time period.

At 414, sales order data for the bucket is received. The sales order data may comprise an order for one or more items, or a cancellation of a previous order. At 416, the counts maintained by the bucket are updated based upon the received sales order data. In some embodiments, if the sales order data comprises information pertaining to items for which a count has not yet been created for, a new count is created in the bucket that corresponds to the item.

In some embodiments, the counts may correspond to a total quantity of items ordered, such that if a sales order contains n of a particular item, then the count for that item is incremented by n. In other embodiments, the counts instead correspond to the total number of line items containing the item. Thus, if a particular order contains a particular item, the count for that item is incremented by 1, regardless of the actual quantity of the item ordered. In some embodiments, after an update, the counts maintained by the bucket may be sorted in order to identify the most frequently ordered items in the time period thus far.

At 418, if the end of the time period has not yet been reached, then sales order data will continue to be received at 414 as it arrives in real time, and used to update the bucket counts at 416. On the other hand, once the end of the time period is reached, the buckets may optionally remove statistically insignificant information at 420, in order to reduce the amount of data and storage space required by the bucket. This may be safely done as subsequent sales order information will no longer pertain to the particular bucket (because they are instead used to update counts maintained by buckets for the next time period). For example, in some embodiments, only the top n item counts may be kept in the bucket, while the rest are discarded. In other embodiments, a top n percent of item counts, or only item counts wherein the count exceeds a certain value n, are kept. What is considered to be statistically insignificant information may be determined by one or more processing options or pieces of customer-specified information. For example, in some embodiments some buckets may remove statistically insignificant information based upon default setting, while other buckets for particular customers may use a different setting.

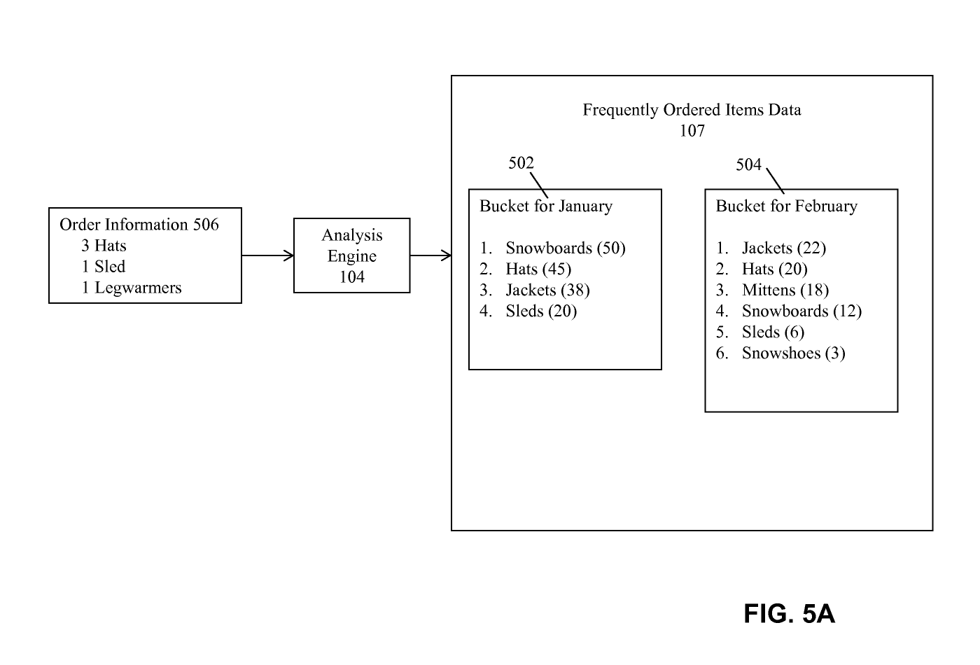

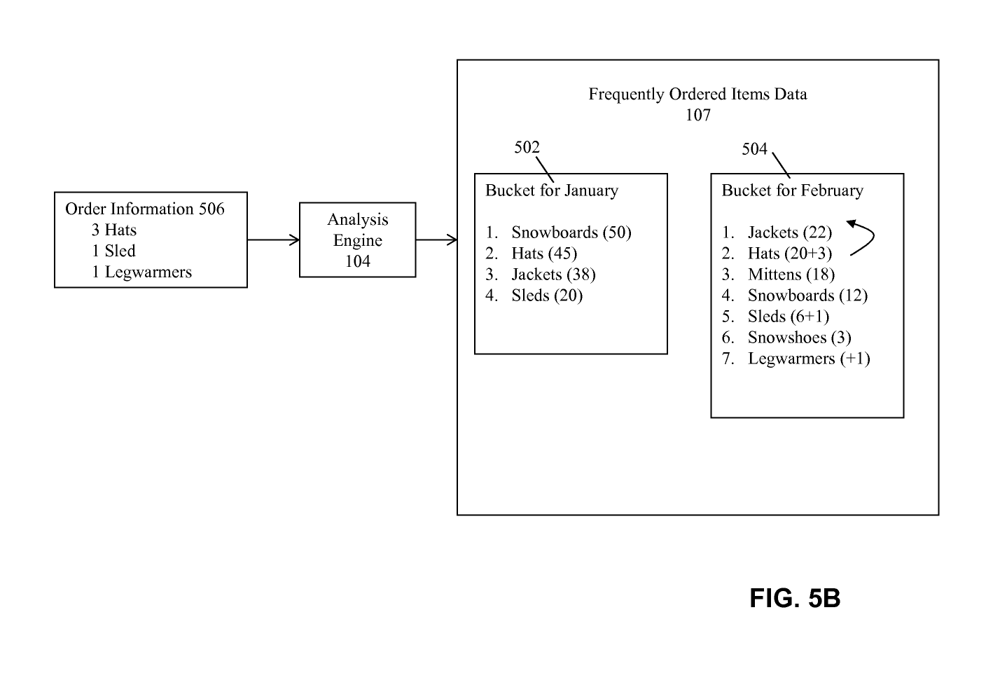

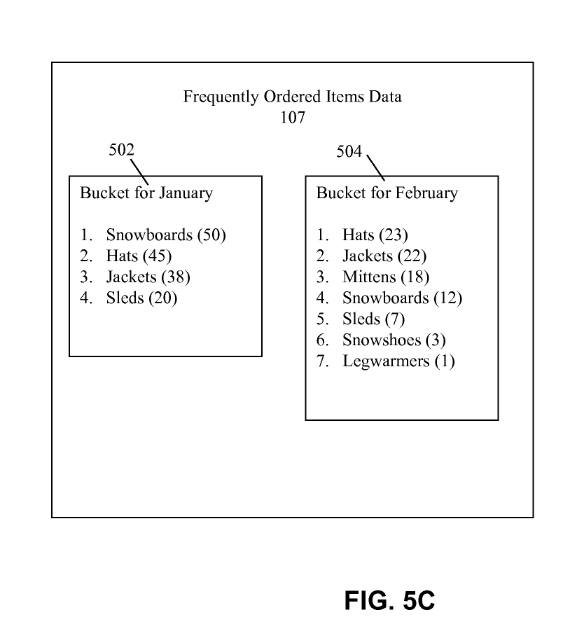

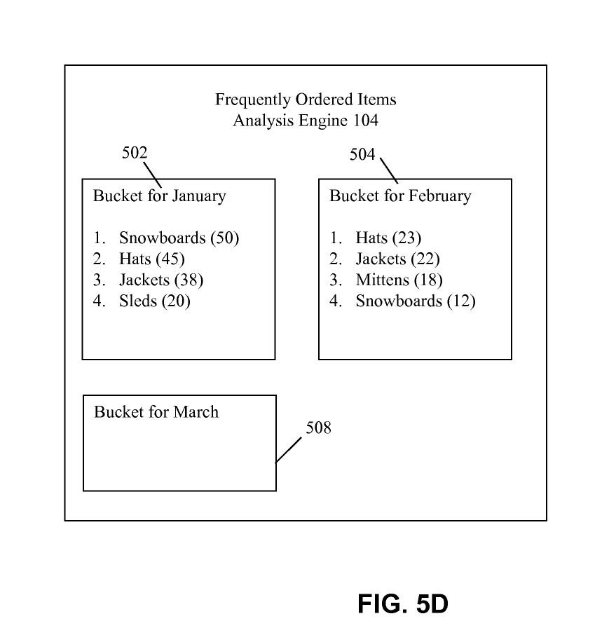

FIGS. 5A-5D illustrate an example of updating buckets with new order information. In the illustrated example, the current month is February. FOI data 107 contains a plurality of buckets, which include a January bucket 502 and a February bucket 504 corresponding to buckets for their respective months in the current year (there may also be buckets corresponding to January and February of past years, which are not shown in the current figure). In the illustrated embodiment, buckets for past time periods are configured to contain counts for the top n items for that month, wherein n is configured to be four. For example, the January bucket 502 stores counts for the top 4 items sold during that month (snowboards, hats, jackets, and sleds). However, because February is the current month, February bucket 504 can still be updated in real-time, and so maintains counts for all items ordered during the month, and not only the top n items.

In FIG. 5A, order information 506 is received at analysis engine 104 and used to update the February bucket 504 in FOI data 107. Order information 506 may contain orders for items for which counts are already being maintained for in February bucket 504 (e.g., hats, sleds), or may contain orders for items for which counts are not yet being maintained for (e.g., legwarmers). This may be because the entity associated with bucket 504 (the customer, customer group) has yet to order the particular product in the particular period for the bucket.

In FIG. 5B, the item counts maintained in February bucket 504 are updated based on the items contained in order information 506. For example, the counts for hats and sleds are incremented by the appropriate amount. Because no count exists for legwarmers, a new count is created in February bucket 504, which is then incremented by the amount indicated in order information 506.

In some embodiments, February bucket 504 may sort its item counts as it is updated in real time. For example, the update following order information 504 caused the count for hats to exceed the count for jackets, in which case the sorting of the counts within February bucket 504 may be updated to reflect this. FIG. 5C illustrates the status of February bucket 504 following the update of order information 506, which reflects the results of sorting.

FIG. 5D illustrates the buckets at the end of the month of February. At the end of the month, February bucket 504 is truncated such that only counts for the n most frequently ordered items are maintained (e.g., top 4 items). As subsequent order information will no longer affect the counts of February bucket 504, the counts for items outside the top n items may be discarded.

In addition, a new bucket 508 for the next month (March) may be created. Because no items have yet been ordered in March, March bucket 508 contains no counts. As orders are received during March, new counts corresponding to ordered items will be created and maintained.

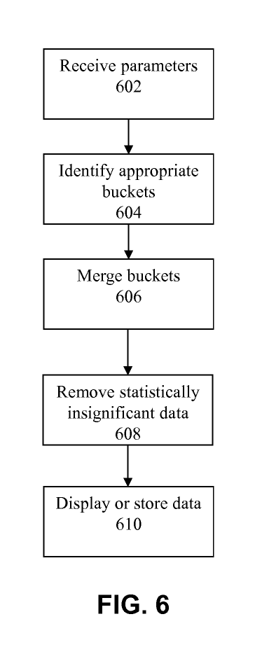

FIG. 6 shows a flowchart of an approach to using the buckets in order to retrieve data for frequently ordered items in order to generate recommendations. At 602, parameters for analysis are received. In some embodiments, this may occur when a customer is placing an order, and it is desired to display a plurality of recommendations for additional products to the customer or CSR. In some embodiments, a default set of parameters may be used, while in other embodiments, various parameters may be defined by the customer or CSR. Parameters may include but are not limited to the time period to be analyzed (e.g., a number of months forward and/or backward, years to include in the analysis period), customer scope (e.g., recommendations based on data for the particular customer, or include related customers, industry segment, etc.), and number of recommendations to generate/display.

At 604, the appropriate buckets are identified based upon the received parameters. For example, if the customer scope is limited to the particular customer for whom recommendations are to be generated for, then only buckets for the customer are identified. If the scope is broader, then additional buckets corresponding to other customers related to the current customer may also be identified (e.g., buckets corresponding to the customer, and those corresponding to other customers in the same industry segment). Buckets are also identified based on the specified time period. For example, if the desired time period is two months back for three years, and the current month is March, then buckets for January through March for the past three years are identified.

At 606, the identified buckets are merged together. This may comprise combining the items counts of the identified buckets. The item counts, once combined, may then be sorted in order to determine the most frequently ordered items across all the analyzed buckets. In addition, because the items in each bucket may be different, the result of merging the buckets may result in a larger number of counts (e.g., combining two buckets with n counts each may result in up to 2n total counts). At 608, statistically insignificant data may optionally be removed. For example, it may be desired to only show a certain number of the most frequently ordered items for the time period being analyzed, or only items that exceed a certain number of orders in the time period. In some embodiments, only the counts for those items are kept, while the rest may be discarded. At 610, the data may be displayed to the customer or CSR, or is stored for later viewing or analysis.

Therefore, what has been described is an improved approach for identifying frequently ordered items. This inventive approach allows the counts for the months that are currently relevant to be summed quickly and ranked at runtime so the items with the highest frequency can be recommended. In addition, this approach provides very up-to-date data at very low levels of incremental expense.

### System Architecture Overview

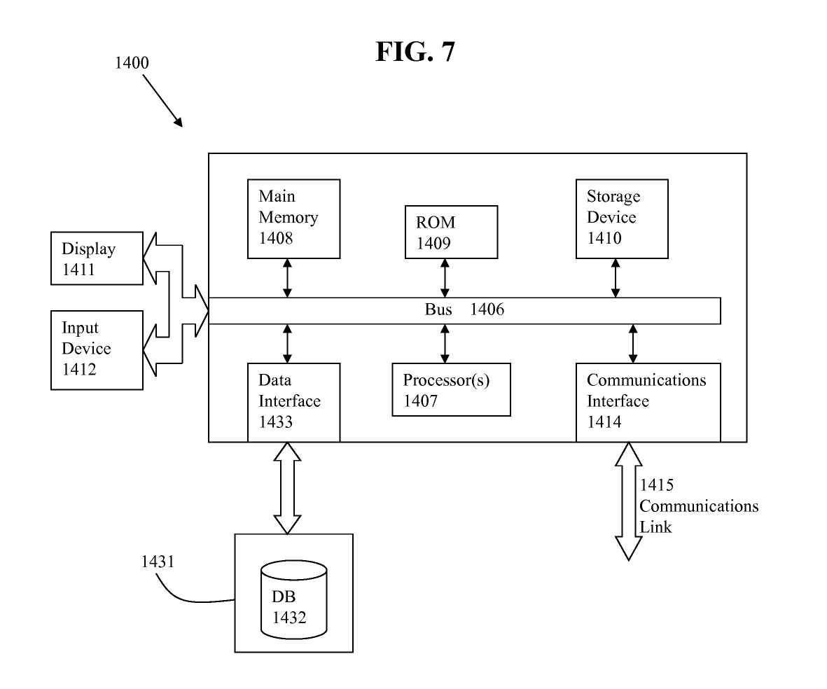

FIG. 7 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to one embodiment of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1415 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A computer implemented method implemented with a processor, comprising:
performing pre-calculations on historical sales data to generate item order frequency data, comprising:
retrieving historical sales data corresponding to an analysis time period;
identifying one or more items associated with the historical sales data;
specifying a plurality of time periods within the analysis time period;
calculating item order frequency data using the retrieved historical sales data, wherein the item order frequency data is associated with the plurality of time periods and the one or more items identified from the historical sales data; and
storing the calculated item order frequency data; and
in response to processing a sales order, updating the stored item order frequency data, wherein updating is performed in real time as the sales order is processed, and comprises:
identifying one or more items associated with the sales order;
determining a time period associated with the sales order;
updating the item order frequency data based at least in part upon the time period and the one or more items associated with the sales order; and
storing or displaying the updated item order frequency data.

2. The method of claim 1, in which the pre-calculated data regarding item order frequency is implemented by generating a set of buckets for the pre-calculated data corresponding to the plurality of time periods.

3. The method of claim 2, in which the set of buckets comprises separate buckets for each month of the analysis time period.

4. The method of claim 3, in which data for a season of time is determined by combining data for multiple months corresponding to a given season.

5. The method of claim 2, in which each of the set of buckets comprises a list of top n items that were ordered in a corresponding time period.

6. The method of claim 1, in which an item order frequency is determined for an individual entity, for a group of entities, or across the board for all entities.

7. The method of claim 1, in which calculating item order frequencies comprises:
receiving processing parameters;
identifying a plurality of entities based at least in part upon the processing parameters;
defining a plurality of buckets corresponding to the plurality of time periods, based at least in part upon the processing parameters;
entering a processing loop for each entity and each bucket period, where the processing loop retrieves historical sales data associated with the entity for the bucket period, performs analysis of item order frequency for the bucket period, and inserts analysis data into a corresponding bucket.

8. The method of claim 7, in which the analysis of the item order frequency comprises identification of top n items ordered in the bucket period or a top percentage of ordered items.

9. The method of claim 1, in which statistically insignificant data is removed.

10. A non-transitory computer readable medium having stored thereon a sequence of instructions which, when executed by a processor causes the processor to execute a method comprising:
performing pre-calculations on historical sales data to generate item order frequency data, comprising:
retrieving historical sales data corresponding to an analysis time period;
identifying one or more items associated with the historical sales data;
specifying a plurality of time periods within the analysis time period;
calculating item order frequency data using the retrieved historical sales data, wherein the item order frequency data is associated with the plurality of time periods and the one or more items identified from the historical sales data; and
storing the calculated item order frequency data; and
in response to processing a sales order, updating the stored item order frequency data, wherein updating is performed in real time as the sales order is processed, and comprises:
identifying one or more items associated with the sales order;
determining a time period associated with the sales order;
updating the item order frequency data based at least in part upon the time period and the one or more items associated with the sales order; and
storing or displaying the updated item order frequency data.

11. The computer readable medium 10, in which the pre-calculated data regarding item order frequency is implemented by generating a set of buckets for the pre-calculated data corresponding to the plurality of time periods.

12. The computer readable medium 11, in which the set of buckets comprises separate buckets for each month of the analysis time period.

13. The computer readable medium 12, in which data for a season of time is determined by combining data for multiple months corresponding to a given season.

14. The computer readable medium 11, in which each of the set of buckets comprises a list of top n items that were ordered in a corresponding time period.

15. The computer readable medium 10, in which an item order frequency is determined for an individual entity, for a group of entities, or across the board for all entities.

16. The computer readable medium 10, in which calculating item order frequencies comprises:
receiving processing parameters;
identifying a plurality of entities based at least in part upon the processing parameters;
defining a plurality of buckets corresponding to the plurality of time periods, based at least in part upon the processing parameters;
entering a processing loop for each entity and each bucket period, where the processing loop retrieves historical sales data associated with the entity for the bucket period, performs analysis of item order frequency for the bucket period, and inserts analysis data into a corresponding bucket.

17. The computer readable medium 16, in which the analysis of the item order frequency comprises identification of top n items ordered in the bucket period or a top percentage of ordered items.

18. The computer readable medium 10, in which statistically insignificant data is removed.

19. A system, comprising:
a processor;
a memory comprising computer code executed using the processor, in which the computer code implements:
performing pre-calculations on historical sales data to generate item order frequency data, comprising:
retrieving historical sales data corresponding to an analysis time period;
identifying one or more items associated with the historical sales data;
specifying a plurality of time periods within the analysis time period;
calculating item order frequency data using the retrieved historical sales data, wherein the item order frequency data is associated with the plurality of time periods and the one or more items identified from the historical sales data; and
storing the calculated item order frequency data; and
in response to processing a sales order, updating the stored item order frequency data, wherein updating is performed in real time as the sales order is processed, and comprises:
identifying one or more items associated with the sales order;
determining a time period associated with the sales order;
updating the item order frequency data based at least in part upon the time period and the one or more items associated with the sales order; and
storing or displaying the updated item order frequency data.

20. The system of claim 19, in which the pre-calculated data regarding item order frequency is implemented by generating a set of buckets for the pre-calculated data corresponding to the plurality of time periods.

21. The system of claim 20, in which the set of buckets comprises separate buckets for each month of the analysis time period.

22. The system of claim 21, in which data for a season of time is determined by combining data for multiple months corresponding to a given season.

23. The system of claim 20, in which each of the set of buckets comprises a list of top n items that were ordered in a corresponding time period.

24. The system of claim 19, in which an item order frequency is determined for an individual entity, for a group of entities, or across the board for all entities.

25. The system of claim 19, in which calculating item order frequencies comprises:
receiving processing parameters;
identifying a plurality of entities based at least in part upon the processing parameters;
defining a plurality of buckets corresponding to the plurality of time periods, based at least in part upon the processing parameters;
entering a processing loop for each entity and each bucket period, where the processing loop retrieves historical sales data associated with the entity for the bucket period, performs analysis of item order frequency for the bucket period, and inserts analysis data into a corresponding bucket.

26. The system of claim 25, in which the analysis of the item order frequency comprises identification of top n items ordered in the bucket period or a top percentage of ordered items.

27. The system of claim 19, in which statistically insignificant data is removed.
